(19) United States
(12) Patent Application Publication
(10) Pub. No.: US 2022/0109722 A1
(43) Pub. Date: Apr. 7, 2022

(54) METHOD AND APPARATUS FOR DYNAMIC WORKFLOW TASK MANAGEMENT

(71) Applicant: Nokia Technologies Oy, Espoo (FI)

(72) Inventors: Yu YOU, Kangasala (FI); Kashyap KAMMACHI SREEDHAR, Tampere (FI); Sujeet Shyamsundar MATE, Tampere (FI)

(21) Appl. No.: 17/450,165

(22) Filed: Oct. 6, 2021

Related U.S. Application Data
(60) Provisional application No. 63/088,610, filed on Oct. 7, 2020.

(51) Int. Cl. H04L 29/08; G06F 9/50; H04L 29/06

(52) U.S. Cl. CPC H04L 67/1012; H04L 65/60; G06F 9/5055; G06F 9/5038

(57) ABSTRACT

An apparatus for dynamic workflow task management in a network based media processing environment is provided. The apparatus includes at least one processor; and at least one non-transitory memory including computer program code; wherein the at least one memory and the computer program code are configured to, with the at least one processor, cause the apparatus at least to perform: generate a capability description document comprising requirement changes for migration of tasks during run-time of a workflow between a cloud and device environments; and trigger follow-up actions to migrate the task during the run-time of the workflow, between the cloud and the device environments, based on the capability description document. Corresponding methods and computer program products are also provided.

### TECHNICAL FIELD

The examples and non-limiting embodiments relate generally to network based media processing, and more particularly, to method and apparatus for dynamic workflow task management.

### BACKGROUND

It is known to provide network based media processing.

### SUMMARY

An example apparatus includes at least one processor; and at least one non-transitory memory including computer program code; wherein the at least one memory and the computer program code are configured to, with the at least one processor, cause the apparatus at least to perform: generate a capability description document comprising requirement resource changes for migration of tasks during run-time of a workflow between cloud and device environments; and trigger follow-up actions to migrate the task during the run-time of the workflow, between the cloud and the device environments, based on the capability description document.

The apparatus may further include, wherein the capability description document includes a media processing entity (MPE) capability description document (MDD).

The apparatus may further include, wherein the apparatus includes a plurality of media processing entities (MPEs) registered for specific processing tasks.

The apparatus may further include, wherein the media processing entities exists over multiple processing environments comprising the cloud and device environments.

The apparatus may further include, wherein the capability description document includes one or more of following capabilities: a name, a description, and an identifier; a repository of built in function; total and currently available hardware resources; or issuing events in case of reducing resource through at least one of notification, reporting, or monitoring.

The apparatus may further include, wherein to generate the capability description document the apparatus is further caused to use the network based media processing (NBMP) workflow description document, wherein the NBMP description document describe at least one of notification, reporting, or monitoring of the MPE.

The apparatus may further include, wherein the NBMP descriptors includes one or more of following: scheme descriptor; general descriptor; repository descriptor; list of supported functions; requirements; or system events.

The apparatus may further include, wherein the apparatus is further caused to incorporate native functions in a processing pipeline.

The apparatus may further include, wherein the native functions join the processing pipeline via a function repository or a workflow manager.

The apparatus may further include, wherein the capability description document includes capabilities of storage definition.

The apparatus may further include, wherein the capabilities of storage definition includes one or more of persistency properties or consistency properties.

The apparatus may further include, wherein the task is implemented as a static task or a mobile task.

The apparatus may further include, wherein the task includes capability to be moved to a different MPE based on an event notification received by a workflow manager.

The apparatus may further include, wherein the mobile task further includes capability to capture an execution state and transfer the execution state to a new location.

The apparatus may further include, wherein the apparatus includes a plurality of media processing entities (MPEs) defined through different MPE capability description document (MCD).

The apparatus may further include, wherein the apparatus is further caused to manage lifecycle of one or more MPEs; and notify, to the workflow manager, a state of each MPE of the one or more MPEs.

The apparatus may further include, wherein a media processing entity includes priority policies regarding availability of resources.

The apparatus may further include, wherein the apparatus further caused to manage media processing entity administration or operation.

The apparatus may further include, wherein media processing entity administration or operation includes a dynamic device discovery, a media processing entity subscription, and a media processing entity un-subscription.

The apparatus may further include, wherein the media processing entity administration or operation is managed via one or more application programming interfaces (APIs).

The apparatus may further include, wherein the one or more application programming interfaces includes interfaces for one or more of following operations: a media processing entity discovery operation, wherein the media processing entity discovery operation includes a mechanism to discover devices with media processing capabilities using the MPE capability description document (MDD); a media processing entity subscription operation to register a device as one or more media processing entities with the capability description document; a media processing entity authentication operation to authenticate the device as one or more media processing entities with the capability description document; a media processing entity sign-off operation to un-subscribe the media processing entity of the device from a processing pipelines; or a capability change operation, used by the device, to inform a workflow manager about changes in resources of the media processing entity.

The apparatus may further include, wherein the apparatus includes one or more of a workflow manager, a user equipment, a network based media processing source, a network based media processing sink, or a server.

The apparatus may further include, wherein the apparatus includes interface and signals to support tasks running on a cloud and end-user devices by using NBMP mobile MPE clients.

Another example apparatus includes at least one processor; and at least one non-transitory memory including computer program code; wherein the at least one memory and the computer program code are configured to, with the at least one processor, cause the apparatus at least to perform register a media processing entity with a persistency and a consistency enabled by network based media processing device; pause a workflow; create temporary queuing tasks with the same input and output capabilities of tasks effected; change a connection map between tasks effected and temporary queuing tasks; and resume workflow and data flow.

Yet another example apparatus includes at least one processor; and at least one non-transitory memory including computer program code; wherein the at least one memory and the computer program code are configured to, with the at least one processor, cause the apparatus at least to perform register a media processing entity with a persistency and a consistency enabled by network based media processing device; pause a workflow; create a read/write queuing channels, wherein the read/write queuing channels includes logic endpoint universal resource locators for data consuming and producing; update input/output descriptors of tasks effected task; and resume workflow and data flow.

An example method includes generating a capability description document to includes requirement changes for migration of tasks during run-time of a workflow between a cloud and device environments; and triggering follow-up actions to the task during the run-time of the workflow, between the cloud and the device environments, based on the capability description document.

The method may further include, wherein the capability description document includes a media processing entity (MPE) capability description document (MDD).

The method may further include, wherein the capability description document includes one or more of following capabilities: a name, a description, and an identifier; a repository of built in functions; total and currently available hardware resources; or issuing events in case of reducing resource through at least one of notification, reporting, or monitoring descriptions.

The method may further include, wherein generating the capability description document includes using network based media processing (NBMP) workflow description document, wherein the NBMP description document describes at least one of notification, reporting, or monitoring of the MPE.

The method may further include, wherein the NBMP descriptors include one or more of following: scheme descriptor; general descriptor; repository descriptor; list of supported functions; requirements; or system events.

The method may further include, incorporating native functions in a processing pipeline.

The method may further include, wherein the native functions join the processing pipeline via a function repository or a workflow manager.

The method may further include, wherein the capability description document includes capabilities of storage definition.

The method may further include, wherein the capabilities of storage definition includes one or more of persistency properties or consistency properties.

The method may further include, wherein the task is implemented as a static task or a mobile task.

The method may further include, wherein the task includes capability to be moved to a different MPE based on an event notification received by a workflow manager.

The method may further include, wherein the mobile task further includes capability to capture an execution state and transfer the execution state to a new location.

The method may further include, managing lifecycle of one or more MPE; and notifying, to the workflow manager, a state of each MPE of the one or more MPEs.

The method may further include, wherein a media processing entity includes priority policies regarding availability of resources.

The method of claim may further include managing media processing entity administration or operation.

The method may further include, wherein media processing entity administration or operation includes a dynamic device discovery, a media processing entity subscription, and a media processing entity un-subscription.

The method may further include, wherein the media processing entity administration or operation is managed via one or more application programming interfaces (APIs).

The method may further include, wherein the one or more application programming interfaces includes interfaces for one or more of following operations: a media processing entity discovery operation, wherein the media processing entity discovery operation comprises a mechanism to discover devices with media processing capabilities using the MPE capability description document (MDD); a media processing entity subscription operation to register a device as one or more media processing entities with the capability description document; a media processing entity authentication operation to authenticate the device as one or more media processing entities with the capability description document; a media processing entity sign-off operation to un-subscribe the media processing entity of the device from a processing pipelines; or a capability change operation, used by the device, to inform a workflow manager about changes in resources of the media processing entity.

Another example method includes registering a media processing entity with a persistency and a consistency enabled by network based media processing device; pausing a workflow; create temporary queuing tasks with the same input and output capabilities of tasks effected; changing a connection map between tasks effected and temporary queuing tasks; and resuming workflow and data flow.

Yet another example method includes registering a media processing entity with a persistency and a consistency enabled by network based media processing device; pausing a workflow; creating a read/write queuing channels, wherein the read/write queuing channels comprise logic endpoint universal resource locators for data consuming and producing; updating input/output descriptors of tasks effected task; and resuming workflow and data flow.

An example computer program product includes a computer readable storage medium having program code portions stored thereon, the program code portions configured, upon execution, to generate a capability description document comprising requirement resource changes for migration of tasks during run-time of a workflow between cloud and device environments; and trigger follow-up actions to migrate the task during the run-time of the workflow, between the cloud and the device environments, based on the capability description document.

Another example computer program product includes a computer readable storage medium having program code portions stored thereon, the program code portions configured, upon execution, to register a media processing entity with a persistency and a consistency enabled by network based media processing device; pause a workflow; create temporary queuing tasks with the same input and output capabilities of tasks effected; change a connection map between tasks effected and temporary queuing tasks; and resume workflow and data flow.

Yet another example computer program product comprising a computer readable storage medium having program code portions stored thereon, the program code portions configured, upon execution, to register a media processing entity with a persistency and a consistency enabled by network based media processing device; pause a workflow; create a read/write queuing channels, wherein the read/write queuing channels comprise logic endpoint universal resource locators for data consuming and producing; update input/output descriptors of tasks effected task; and resume workflow and data flow.

The computer program product as described in any of the previous paragraphs, wherein the computer program product includes a non-transitory computer readable medium.

Still another example apparatus includes: at least one processor; and at least one non-transitory memory including computer program code; wherein the at least one memory and the computer program code are configured to, with the at least one processor, cause the apparatus at least to perform: generate a capability description document comprising one or more of following capabilities or properties: a name, a description, or an identifier of a media processing entity; location of the media processing entity in a media processing workflow; available hardware resources; persistency properties or capabilities; or security parameters.

The example apparatus may further include, wherein the capability description document comprises capabilities of storage definition.

The example apparatus may further include, wherein the capabilities of storage definition comprise one or more of persistency properties or consistency properties.

The example apparatus may further include, wherein a media processing entity comprises priority policies regarding availability of resources.

The example apparatus may further include, wherein the apparatus further caused to manage media processing entity administration.

The example apparatus may further include, wherein media processing entity administration comprises a dynamic media processing entity device discovery, a media processing entity subscription, and a media processing entity un-subscription.

The example apparatus may further include, wherein the media processing entity administration is managed via one or more application programming interfaces (APIs).

The example apparatus may further include, wherein the one or more application programming interfaces comprises interfaces for one or more of following operations: a media processing entity discovery operation, wherein the media processing entity discovery operation comprises a mechanism to discover devices with media processing capabilities using the MPE capability description document (MDD); a media processing entity subscription operation to register a device as one or more media processing entities with the capability description document; a media processing entity authentication operation to authenticate the device as one or more media processing entities with the capability description document;

a media processing entity sign-off operation to un-subscribe the media processing entity of the device from a processing pipelines; or a capability change operation, used by the device, to inform a workflow manager about changes in resources of the media processing entity.

A still another example method includes: generating a capability description document comprising one or more of following capabilities or properties: a name, a description, or an identifier of a media processing entity; location of the media processing entity in a media processing workflow; available hardware resources; persistency properties or capabilities; or security parameters.

The example method may further include, wherein the capability description document comprises capabilities of storage definition.

The example method may further include, wherein the capabilities of storage definition comprise one or more of persistency properties or consistency properties.

The example method may further include, wherein a media processing entity comprises priority policies regarding availability of resources.

The example method may further include managing media processing entity administration.

The example method may further include, wherein media processing entity administration comprises a dynamic media processing entity device discovery, a media processing entity subscription, and a media processing entity un-subscription.

The example method may further include, wherein the media processing entity administration is managed via one or more application programming interfaces (APIs).

The example method may further include, wherein the one or more application programming interfaces comprises interfaces for one or more of following operations: a media processing entity discovery operation, wherein the media processing entity discovery operation comprises a mechanism to discover devices with media processing capabilities using the MPE capability description document (MDD); a media processing entity subscription operation to register a device as one or more media processing entities with the capability description document; a media processing entity authentication operation to authenticate the device as one or more media processing entities with the capability description document; a media processing entity sign-off operation to un-subscribe the media processing entity of the device from a processing pipelines; or a capability change operation, used by the device, to inform a workflow manager about changes in resources of the media processing entity.

A still another example computer program product includes a computer readable storage medium having program code portions stored thereon, the program code portions configured, upon execution, to: generate a capability description document comprising one or more of following capabilities or properties: a name, a description, or an identifier of a media processing entity; location of the media processing entity in a media processing workflow; available hardware resources; persistency properties or capabilities; or security parameters.

The example computer program product may further include, wherein the apparatus is further caused to perform the method as described in any of the previous paragraphs.

The example computer program product may further include, wherein the computer program product comprises a wherein the computer readable comprises a non-transitory computer readable medium.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram of an apparatus that may be configured in accordance with an example embodiment.

FIG. 5 illustrates an example network-based media processing (NBMP) environment, in accordance with an embodiment.

FIG. 6 depicts an NBMP Workflow consists of one or more tasks, in accordance with an embodiment.

FIG. 7 shows an NBMP processing flow, in accordance with an embodiment.

FIG. 8 illustrates an example of split-rendering of FIG. 6, in accordance with an embodiment.

FIG. 9 illustrates an example NBMP workflow, in accordance with an embodiment.

FIG. 10 illustrates design of an MPE, in accordance with an example embodiment.

FIG. 11 illustrates a communication between a workflow manager and MPEs, in accordance with an example embodiment.

FIG. 12 depicts an example for MPE and function registration, in accordance with an embodiment.

FIG. 13 depicts a another example for MPE and function registration, in accordance with another embodiment.

FIG. 14 depicts yet another example for MPE and function registration, in accordance with yet another embodiment.

FIG. 15 is a diagram illustrating an example apparatus configured to implement dynamic workflow task management in a network based media processing environment, in accordance with an embodiment.

FIG. 16 is a flow chart illustrating the operations performed for respecting MPE data persistency for running workflow and task, in accordance with an embodiment.

FIG. 17 depicts event notification for processing capability changes on device MPEs, in accordance with an embodiment.

FIG. 18 describes changes in task happening during transfer of a task, in accordance with an embodiment.

FIG. 19 is a flowchart illustrating a method for implementing dynamic workflow task management in a network based media processing environment.

FIG. 20 is a flowchart illustrating a method for generating a capability description document, in accordance with an embodiment.

FIG. 21 is a diagram illustrating the communication between MPE and workflow manager, in accordance with an embodiment.

FIG. 22 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AI artificial intelligence
AIoT AI-enabled IoT
a.k.a. also known as
AMF access and mobility management function
AVC advanced video coding
CABAC context-adaptive binary arithmetic coding
CDMA code-division multiple access
CE core experiment
CU central unit
DASH dynamic adaptive streaming over HTTP
DCT discrete cosine transform
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
gNB (or gNodeB) base station for 5G/NR, for example, a node providing NR user plane and control plane protocol terminations towards the UE, and connected via the NG interface to the 5GC
GSM Global System for Mobile communications
H.222.0 MPEG-2 Systems is formally known as ISO/IEC 13818-1 and as ITU-T Rec. H.222.0
H.26x family of video coding standards in the domain of the ITU-T
HLS high level syntax
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
ISO International Organization for Standardization
ISOBMFF ISO base media file format
ITU International Telecommunication Union
ITU-T ITU Telecommunication Standardization Sector
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
MCD MPE capability description
mdat MediaDataBox
MME mobility management entity
MMS multimedia messaging service
moov MovieBox
MP4 file format for MPEG-4 Part 14 files
MPE media processing entity
MPEG moving picture experts group
MPEG-2 H.222/H.262 as defined by the ITU
MPEG-4 audio and video coding standard for ISO/IEC 14496
MSB most significant bit
NAL network abstraction layer
NBMP network-based media processing
NDU NN compressed data unit
ng or NG new generation
ng-eNB or NG-eNB
NN neural network
NNEF neural network exchange format
NNR neural network representation
NR new radio (5G radio)
N/W or NW network
ONNX Open Neural Network eXchange
PB protocol buffers
PC personal computer
PDA personal digital assistant
PDCP packet data convergence protocol
PHY physical layer
PID packet identifier
PLC power line communication
PSNR peak signal-to-noise ratio
RAM random access memory
RAN radio access network
RFC request for comments
RFID radio frequency identification
RLC radio link control
RRC radio resource control
RRH remote radio head
RU radio unit
Rx receiver
SDAP service data adaptation protocol
SGW serving gateway
SMF session management function
SMS short messaging service
st(v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
trak TrackBox
TS transport stream
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
WDD workflow description document
WLAN wireless local area network
X2 interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to provide system and key interfaces with signaling for dynamic native function addressability or discovery, function registration, and deregistration in a network or distributed workflow processing environment. A method, apparatus and computer program product are provided in accordance with further example embodiment in order to provide mechanism for dynamic workflow task management in a network based media processing environment.

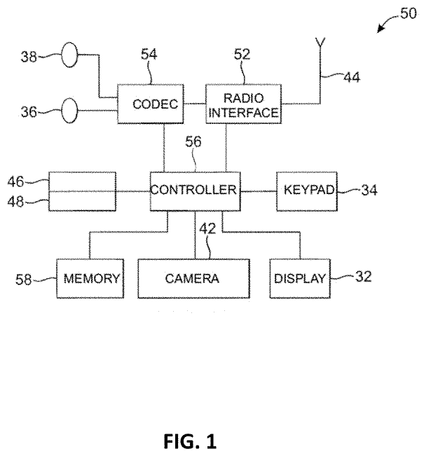

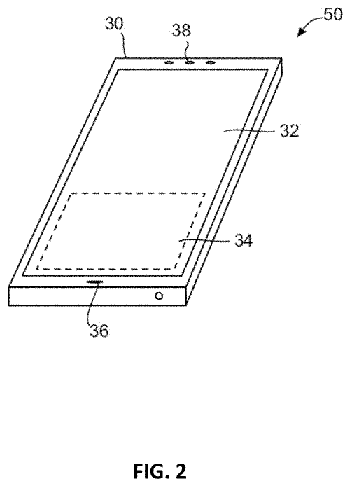

The following describes in detail suitable apparatus and possible mechanisms for network based media processing according to embodiments. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may for example be a mobile terminal or user equipment of a wireless communication system, a sensor device, a tag, or a lower power device. However, it would be appreciated that embodiments of the examples described herein may be implemented within any electronic device or apparatus which may process data in communication network.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display media or multimedia content, for example, an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera 42 capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

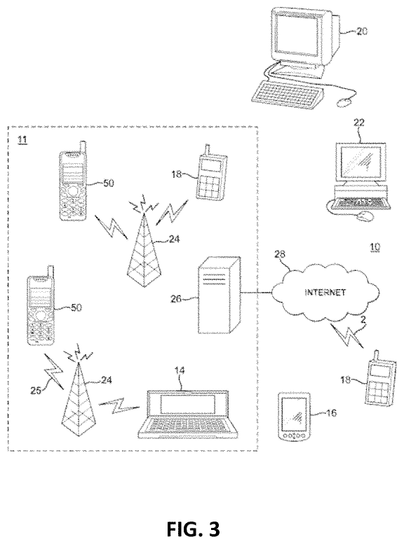

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network, and the like), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included the Internet of Things (IoT). In order to utilize Internet IoT devices are provided with an IP address as a unique identifier. IoT devices may be provided with a radio transmitter, such as WLAN or Bluetooth transmitter or a RFID tag. Alternatively, IoT devices may have access to an IP-based network via a wired network, such as an Ethernet-based network or a power-line connection (PLC).

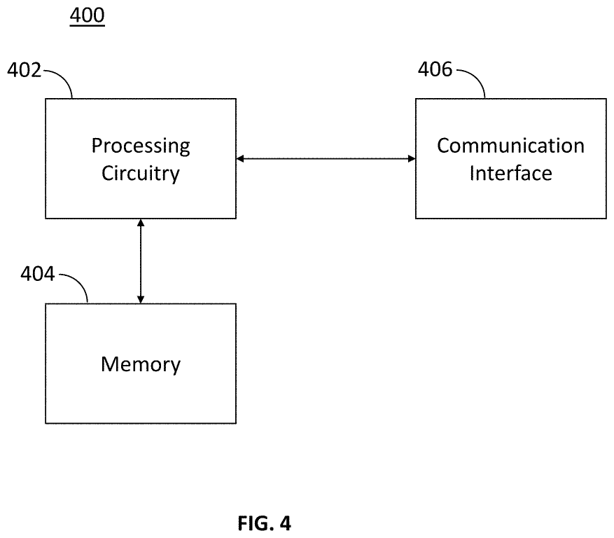

An apparatus 400 is provided in accordance with an example embodiment as shown in FIG. 4. In one embodiment, the apparatus of FIG. 4 may be embodied by a server. In an alternative embodiment, the apparatus may be embodied by an end-user device, for example, by any of the various computing devices described above. In either of these embodiments and as shown in FIG. 4, the apparatus of an example embodiment includes, is associated with or is in communication with processing circuitry 402, one or more memory devices 404, a communication interface 406 and optionally a user interface.

The processing circuitry 402 may be in communication with the memory device 404 via a bus for passing information among components of the apparatus 400. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 400 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 402 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 402 may be configured to execute instructions stored in the memory device 404 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 406 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 400 may optionally include a user interface that may, in turn, be in communication with the processing circuitry 402 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

Network-Based Media Processing (NBMP)

Network-based media processing (NBMP) is a new standard (ISO/IEC 23090-8) in MPEG MPEG-I.

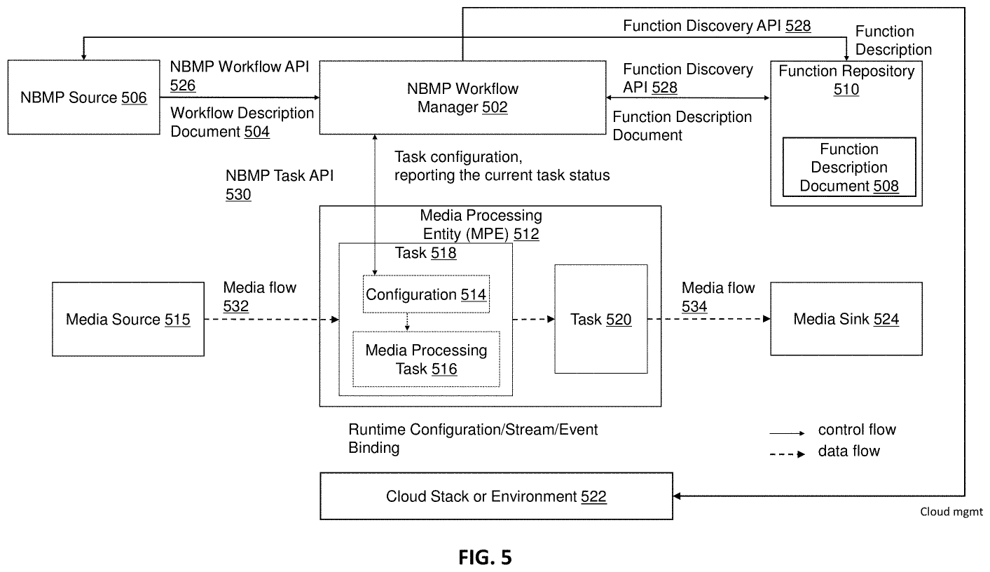

FIG. 5 illustrates an example network-based media processing (NBMP) environment 522, in accordance with example embodiments of the invention. The example environment is a version of the ISO/IEC NBMP standard 23090-8, which is available at ISO web site: [https://www.iso.org/standard/77839.html (last accessed on Oct. 4, 2021)]. NBMP enables offloading media processing tasks to the network-based environment like the cloud computing environments.

As shown in FIG. 5 there is an NBMP source 506 providing an NBMP workflow API with a workflow description 504 to an NBMP workflow manager 502, may also be referred to as workflow manager in some embodiments. As shown in FIG. 5 the NBMP workflow manager 502 is processing the NBMP workflow API with a function repository 510, which includes a function description document 508, and the NBMP source 506 is also exchanging a function discovery API 528 and function description with the function repository 510. Then as shown in FIG. 5 the NBMP workflow manager 502 provides to a media processing entity (MPE) 512 the NBMP task API 533 including task configuration and reporting the current task status. As shown in FIG. 5 the media processing entity (MPE) 512 processes the media flow 532 from the media source 515 by using a task 518, configuration 514, and media processing task 516 to generate a task 520. Then as shown in FIG. 5 a media flow 535 is output towards the media sink 524. As shown in FIG. 5 the operations at 526, 528, and 530 include control flow operations, and the operations 532, and 534 include data flow operations.

NBMP processing relies on a workflow manager, that can be virtualized, to start and control media processing. The Workflow Manager receives a Workflow Description from the NBMP Source, which instructs the Workflow Manager about the desired processing and the input and output formats to be taken and generated, respectively.

The workflow manager (the Manager) creates a workflow based on the workflow description document (WDD) that it receives from the NBMP Source. The workflow manager selects and deploys the NBMP Functions into selected media processing entities and then performs the configuration of the tasks. The WDD can include a number of logic descriptors.

The NBMP can define APIs and formats such as Function templates and workflow description document (WDD) consisting of a number of logic descriptors. NBMP uses the so-called descriptors as the basic elements for its all resource documents such as the workflow documents, task documents, and function documents. Descriptors are a group of NBMP parameters which describe a set of related characteristics of Workflow, Function or Task. Some key descriptors are General, Input, Output, Processing, Requirements, Configuration etc.

In order to hide workflow internal details from the NBMP Source, all updates to the workflow are performed through Workflow Manager. The manager is the single point of access for the creation or change of any workflows. Workflows represent the processing flows defined in WDD provided by NBMP Source (aka. the client). A workflow can be defined as a chain of tasks, specified by the “connection-map” Object in the Processing Descriptor of the WDD.

The Workflow Manager may use pre-determined implementations of media processing functions and use them together to create the media processing workflow. NBMP defines a Function Discovery API that it uses with a Function Repository to discover and load the desired Functions.

A Function, once loaded, becomes a Task, which is then configured by the Workflow Manager through the Task API and can start processing incoming media. It is noted that a cloud and/or network service providers can define their own APIs to assign computing resources to their customers.

There is an increasing deployment of distributed processing infrastructure where the processing nodes or MPEs (in NBMP context) can be located in the cloud or the edge or even on the end user device. One example of such a use case is the split-rendering process employed in cloud gaming services.

Leveraging such a distributed environment requires that an MPE, which is the task execution context, to span over different processing entities.

The exploitation of the distributed environment can range from moving a task or a workflow, partially or entirely, from one infrastructure to another. For example, transferring a last rendering task in a workflow from edge to an end user device or vice versa.

The NBMP Technology considers the following requirements for the design and development of NBMP:
It may be possible for the NBMP Sink to influence the NBMP workflow:
   i. To control the workload split between the sink and the network
   ii. To dynamically adjust the workload split based on changes in client status and conditions
   iii. It may be possible to support streaming of media and metadata from the network to the sink in different formats that are appropriate to the different workload sharing strategies

Splitting Workflow

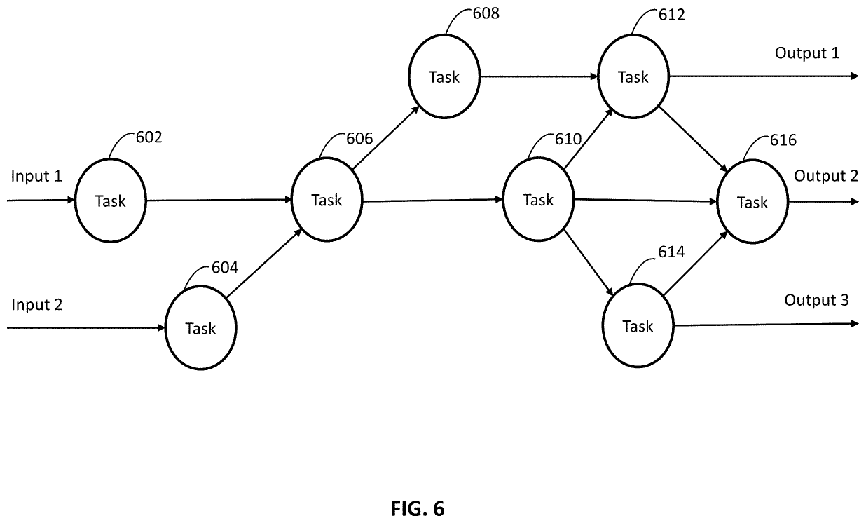

As shown in FIG. 6, an NBMP Workflow consists of one or more tasks, for example, tasks 602, 604, 606, 608, 610, 612, 614, and 616.

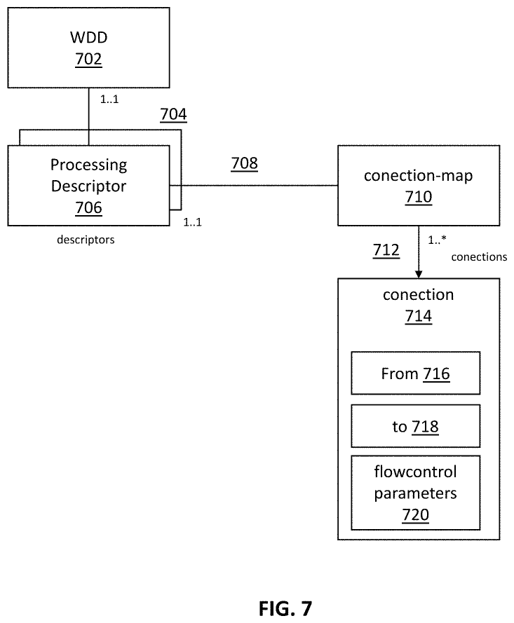

FIG. 7 shows an NBMP processing flow, in accordance with an embodiment. As shown in FIG. 7 the WDD 702 communicates via link 704 with a processing descriptor 706 and via link 708 to a connection map 710 and then via link 712 using one or multiple connections 714, which defines “from” and “to” tasks (for example, 716 and 718 in FIG. 7) and flow control parameters 720.

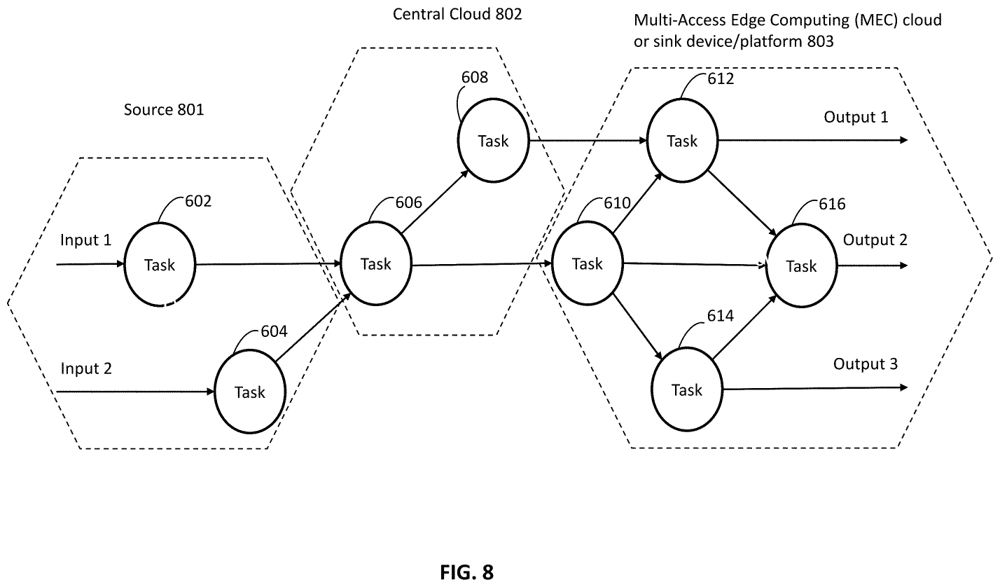

In split-rendering, some of the tasks of a workflow may be implemented in a distributed infrastructure including the media source and/or the media sink. The embodiments herein are not restricted to only media source and/or media sink but can include any other device which may subscribe in the run-time of the workflow using the functionalities presented in this document. FIG. 8 shows an example of the split-rendering of FIG. 8. As depicted in FIG. 8:
Tasks 602 and 604 are implemented on a source device/platform 801;
Tasks 606 and 608 are implemented on a central cloud environment 802; and
Tasks 610, 612, 614, and 616 are implemented on a MEC cloud sink device/platform 803.

Proposed Methodology in Accordance with an Embodiments

In this embodiment, to accommodate split rendering in NBMP, following parameters/criteria are considered:
1. Capabilities of source, sink and network elements; and
2. Which tasks should be run on each device or network element.

MPE Capabilities Description

An MPE can be part of any mobile device/network element including the media source and/or media sink. MPE capabilities Description include, but are not limited to:
1. Name, description, and identifier;
2. A repository of built-in functions and optionally resource requirements;
3. Total and currently available hardware resources including processing, memory and disk space;
4. Currently available throughput and latency capabilities;
5. Currently available battery/power; and
6. Issuing events in case of reducing resource

The description uses NBMP descriptors, including but not limited to, following descriptors:
1. Scheme Descriptor;
2. General Descriptor;
3. Repository Descriptor;
4. List of supported functions;
5. Requirements; and
6. System events

The MPE Capabilities Description (MD) is defined in Table 1.

| Descriptor | Additional constraints | Cardinality |
|---|---|---|
| General | The ‘id’ shall be unique among all MPEs, | 1 |
| | including Source and Sink. | |
| | Following parameters shall not be present: | |
| | rank | |
| | published-time | |
| | priority | |
| | execution-time | |
| | input-ports | |
| | output-ports | |
| | is-group | |
| | state | |
| Repository | None. | 0-1 |
| | The repositories define the list of functions | |
| | that are supported by the MPE. | |
| Functions | Array of supported Function Description. | 0-1 |
| Capabilities | This descriptor is used to describe the | 0-1 |
| (same | capabilities: | |
| descriptor as | 1. Flow control defines the range of | |
| Requirements) | current capabilities | |
| | 2. Hardware defines the hardware | |
| | capabilities | |
| | 3. Security parameters defines the | |
| | supported security features | |
| | Following parameters shall not be present: | |
| | Workflow/Task requirement parameters | |
| | Resource estimator parameters | |
| Events | This descriptor lists events for source | 0-1 |
| | or sink in the case of reduced resource | |
| | availability such as low cpu, low gpu, | |
| | low memory, low bandwidth, low disk, | |
| | low power. | |

Cardinality: 1 = exactly one, 0-1 = zero or one

Various embodiments of the present invention, provide a mechanism to cover the communication between a mobile device and the workflow manager and other features such as security/encryption of the mobile device.

Various embodiments describe a design to allow dynamic and mobile computing environment changes. Further, various embodiments propose the following:
an extension for temporary processing task discovery and registration;
extend NBMP (Workflow Manager) with interface and signals to support tasks running on the cloud/edge/premise, as well as end-user devices, with the help of NBMP Mobile MPE clients;
method for incorporating native functions in the processing pipeline. Native functions can join the processing pipeline in following example ways:
   i. via function repository for all workflows. NBMP Source can discover platform-specific functions via function discovery API provided by function repository; and
   ii. via workflow manager directly: NBMP Source is not aware of such platform-specific function/implementation. Deployed workflow instances can run as before without NBMP source; however this may need changes to WDD.
extension to MPE Capability Description (MCD)) with the capabilities of storage definition with properties such as persistency and consistency. They can be properties of MPE, or Input and Output Descriptors.

Persistency, for example, may refer to the availability of data from a persistent versus volatile storage. A persistent storage can be expected to be available whereas volatile storage needs to be initialized again. For example, a persistent storage is readily accessible after moving a task to a new environment during workflow execution. However, a non-persistently stored data needs to be retrieved and made available again for the task after moving to a new environment. Cloud storage is an example of persistent storage. Local storage on MPE is an example of non-persistent or volatile storage.

Consistency refers to how recent is the snapshot of the data. In case of data, which is constantly updating, there may be multiple data storage URLs with different consistency values. The value can only be greater than or equal to 0, with 0 indicating the data being consistent, e.g. no newer version is available. The value greater than 0 indicates that this version of the data is older than the most recent version of the data. In some embodiments, the value may indicate time in milliseconds.

### Terminologies

NBMP: ISO/IEC 23090-8 Network-based Media Processing. The NBMP framework defines the interfaces including both data formats and APIs among the entities connected through the digital networks for media processing.

Workflow: A sequence of tasks connected as a graph that processes the media data.

MPE: A Media Processing Entity (MPE) runs processing tasks applied on the media data and the related metadata received from media sources or other tasks. A media processing task is a process applied to media and metadata input(s), producing media data and related metadata output(s) to be consumed by a media sink or other media processing tasks (for example, as shown in FIG. 6).

MPE Capability Description or MPE Description (MCD/MD): a logical description of details of a NBMP media processing entity (MPE). MPE Capabilities description document (MDD) is a document containing MCD in the JSON representation format. MPE capabilities resource (MCR or MR) is a rest resource that contains MDD.

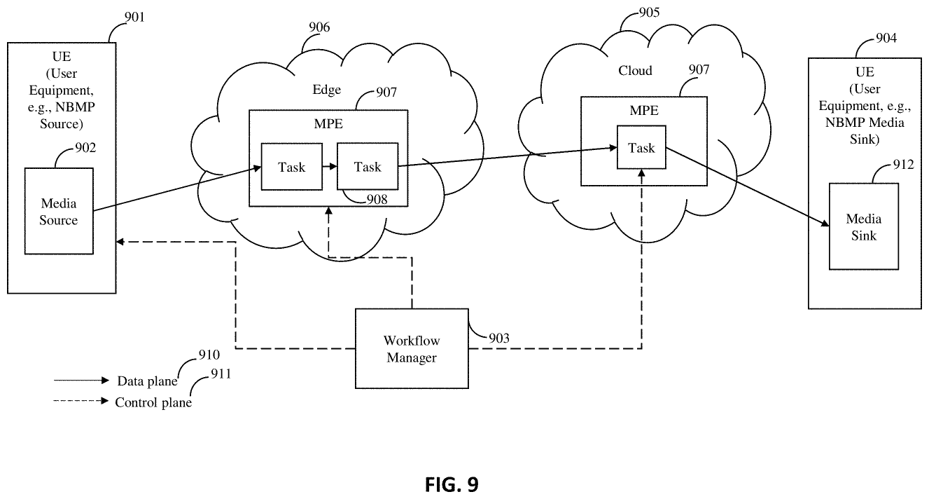

FIG. 8 illustrates an example NBMP workflow, in accordance with an embodiment. As shown in FIG. 9, NBMP may be split into two planes, a control plane 911 and a data plane 910. The control plane 911 includes: workflow API, which may be used by the end-ser equipment UE 901, e.g., NBMP source to create a media processing workflow made up by tasks 908 through a workflow manager 903. Tasks 908 can run inside processing entities (MPE) 907 in the Cloud 905, or in the Edge 906. Workflow manager 903 can run in any places, not necessarily in the same Cloud 905 or Edge 906 environments.

NBMP uses data plane to define media formats, the metadata, and the supplementary information formats between the Media source 902 and the task 908, as well as between the tasks 908, and Media Sink 912. Media source 902 and Media Sink 912 can be in the same UE 901, or in different UEs (901 and 904).

NBMP devices, for example, user equipments 901 and 904, edge 906, cloud 905, and workflow manager 903 communicate via the control and data planes.

Design

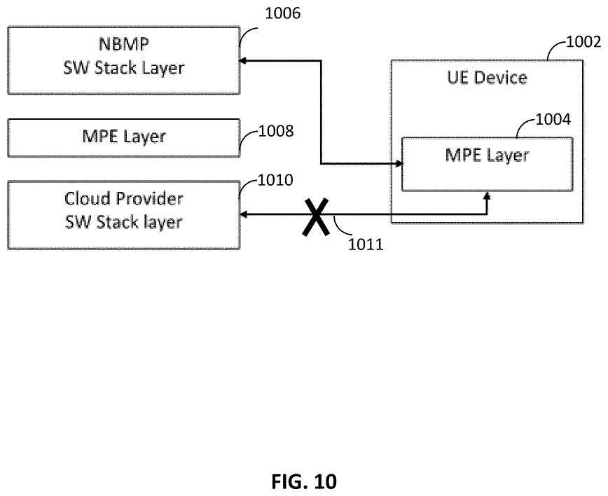

FIG. 10 illustrates design of an MPE, in accordance with an example embodiment. Usually MPEs are logic component to the virtualized computing nodes provided by the cloud providers, for example, virtual machines or Linux containers with a common central processing unit (CPU), for example, X86-64. In an example, end-user equipments (UEs), for example, UE device 1002 use a different CPU architecture, for example, ARM CPU, which may not be binary compatible. Accordingly, MPEs for UEs may not be managed by the cloud provide (shown as a dead-link 1011) and should be known and managed by the NBMP workflow manager as a special device-provisioned MPE rather than cloud or edge provisioned MPE. MPE design also includes MPE layer 1004, NBMP SW stack layer 1006, MPE layer 1008, cloud provider SW stack layer 1010.

Design: MPE as a Portable Execution Context for NBMP Tasks

A context is an abstract layer that includes following features:
Properties as an execution environment for workflow manager to launch tasks, for example, physical, virtual, container or application environments
Properties about hardware environment, for example, operating system, CPU architecture, as well as computing resources like memory, CPU, and graphics processing unit information
Provides storage properties regarding persistency and consistency. It affects when tasks handle data when they are migrated from one MPE to another MPE
Provides function descriptors that have the possible same brand identifiers to cloud-based functions but different identifiers like platform specific identifiers for the workflow manager
Provides entries to NBMP function repository for dynamic function discovery for native or built in media processing functions

In an embodiment, tasks may be implemented as mobile or static tasks. The mobile tasks have capabilities to be moved to a different host depending on event notifications received by the workflow manager, for example task migration with same task implementation or image. Th mobile tasks have additional feature, as compared to the static or normal tasks, of capturing the execution state and transferring it to the new location, for example allowing persistency of task states. The new location can be unique identifier of an MPE, for example virtual hostname or IP address of the MPE in the operational network of the given workflow. In ISO NBMP standard, for example, the connection between two tasks is defined as a link or connection in the “connection-map” object. In the case of mobile tasks, those links may contain properties to indicate the connection states, such as “virtual” for virtual and dynamic connections; or “breakable” for breakable connections. Those property value may mandate those two connected tasks shall be run in different MPE or not.

In another embodiment, one device can have one MPE registered for specific processing task. One device can have more than one MPEs defined through different MPE Capability Descriptor (MCD) documents with different capabilities such as HW resource constraints and specific function description documents (FDDs).

In an embodiment, it is the job of the device to manage the lifecycle of one or all MPEs and notify the workflow manager the MPE states, respectively and independently. In an alternate embodiment, the workflow manager manages the lifecycle of one or all MPEs hosted in the device.

Multiple MPEs may have different priority policies regarding the underlying availability of device resources.

Communication Between Workflow Manager and MPEs

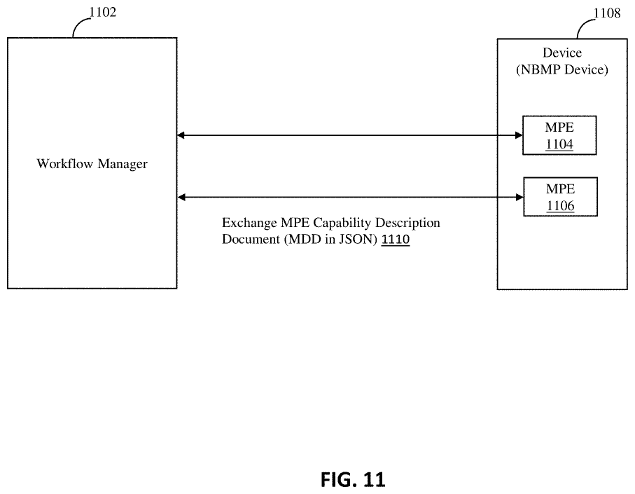

FIG. 11 illustrates a communication between a workflow manager, for example, a workflow manager 1102 and MPEs, for example MPEs, for example, MPEs 1104 and 1106. In this embodiment, device 1108 is shown to include MPEs 1104 and 1006. Workflow manager 1102 provides interfaces 1110 for managing MPE features including dynamic device MPE discovery, MPE subscription, and un-subscription, through which some workflow extension APIs are defined. Some of example operations are described below:
MPE discovery operation: A mechanism to discover devices with MPE capabilities using MPE capability descriptor document.
MPE network connectivity restriction detection: A mechanism to detect any restrictions in connectivity such as firewalls, network address translation (NATs), access-control lists (ACLs) among other restrictions with MPE capability description document.
MPE subscription operation: A device can register itself as one or multiple MPEs with MPE capability description document.
MPE authentication operation: A device can authenticate itself as one or multiple MPEs with MPE capability description document.
MPE sign-off operation: Like subscription, a device can un-subscribe its MPE from the processing pipelines. It may affect one or multiple running workflows.
Capability change operation: Device informs Workflow Manager about MPE resource changes. Resources including HW and functions are dynamic and changing with time. The available HW resources (including memory and CPU metrics) needs signals to the workflow manager, as well as the available functions.

MPE and Function Registration

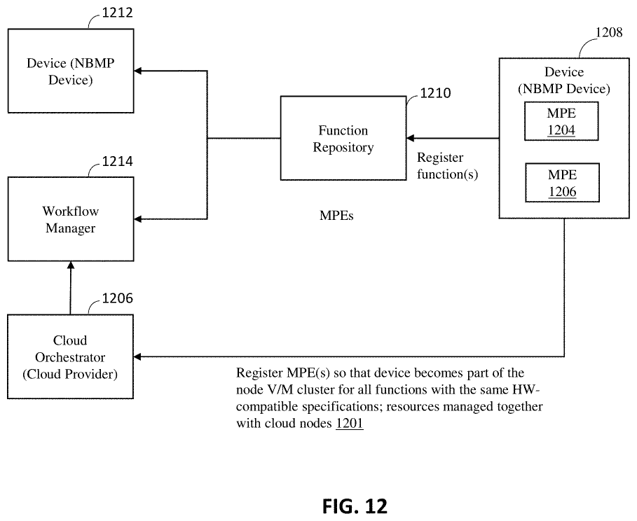

FIG. 12 depicts an example for MPE and function registration 1201, in accordance with an embodiment. In this embodiment, MPEs 1202 and 1204 are registered to a cloud 1206 in order to run other tasks than the native ones. In the first example, the MPEs 1202 and 1204 are included in device 1208. This requires the function implementation to be available in the compatible mode with the device environment, typically the CPU architecture, for example, X86 or ARM. FIG. 12 is shown to further include function a repository 1210, a device 1212, and a workflow manager 1214.

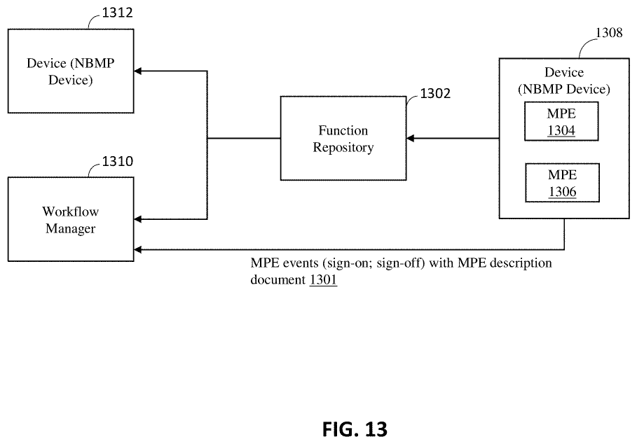

FIG. 13 depicts another example for MPE and function registration 1301, in accordance with another embodiment. FIG. 13. shows another static way of MPE registration through an NBMP Function Repository 1302 with the function register API. This approach excludes potential deployment of other cloud-functions to device MPEs, for example, MPEs 1304 and 1306 included in device a 1308. This approach, therefore, requires the registered function descriptions containing unique MPE identifiers. The MPE identifiers can be the IPs of the devices plus the name of the MPEs given by the device 1308. The device 1208 must notify a workflow manager 1310 with an availability property, when a device function becomes unavailable. There are two cases for unavailability: 1) unavailable temporarily; 2) unavailable permanently. The workflow manager 1310 can make decisions to terminate the workflow; pause the execution; or launch new task instance(s) in the cloud MPE(s) and continue the workflow with updated output information. FIG. 13 is shown to further include a device (also referred to as NBMP device) 1312.

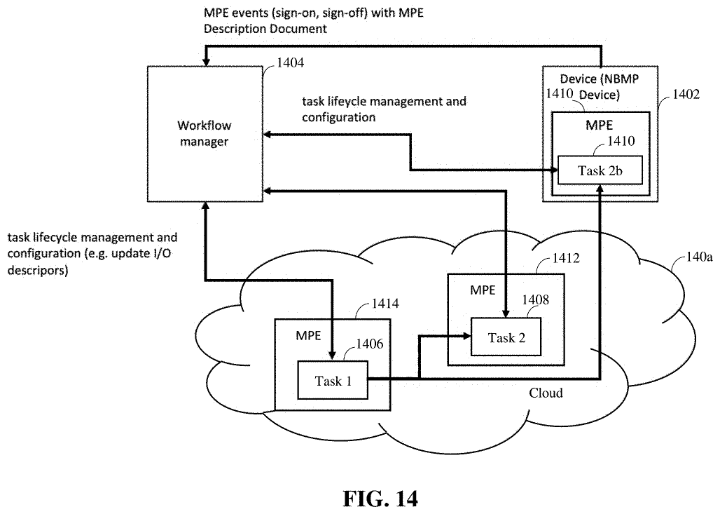

FIG. 14 depicts yet another example for MPE and function registration, in accordance with yet another embodiment. This example includes a dynamic and temporary approach, where NBMP devices, for example, a device 1402 can communicate directly with a workflow manager 1404 without using a function repository. The device 1402 informs the workflow manager 1404 about the availability of MPEs and native functions in a function description document. Optionally, the device can also indicate the workflow sessions (workflow IDs) to which the native functions intend to take over. On receiving notification event, the workflow manager 1404 can acknowledge and configurate the native tasks on the device MPE, when they are in the appropriate states, e.g. instantiated states as defined by NBMP framework.

As illustrated in FIG. 14, the workflow manager 1404 can change the running workflow by changing the connection between a task 1406 and task 1408, e.g. a flow control parameter of the ‘connection-map’ 730 in FIG. 7 of a workflow description document and re-configure Task 1406 and task 1410 with new connection information, for example, new network addresses and network port numbers in the input and output descriptors through the NBMP task API. In an embodiment, each task runs as a service, analogous to the micro-service architecture. After the re-wiring process, the task 1408 can be put to idle state and kept in a standby mode for future wakeup by the workflow manager 1404; or destroyed completely to free some resources. FIG. 14 is also shown to include MPEs 1410, 1412, and 1414 running in different locations, for example, 1416 indicates the central cloud environment, where the MPE 1410 is located on the device 1402.

MPE Capability Description Parameters Related to Storage

MPE capability description may include other parameters together with function descriptions. A transparent data persistency and consistency refers to the ability to move any data in one MPE to another MPE during the migration of tasks.

In an embodiment, the storage parameters like persistence-storage-url property may be used directly, or converted to the part of the input and output descriptors, so they are specific to individual input or/and output of one task. Some example parameters are described below:
Data persistency type:
   i. Type can be local storage, and remote storage such as edge storage, cloud storage with different latency requirements
   ii. Local storage does not provide data persistency. Local stored data URL can use “local://” as its schema part. Remote data URLs can have other schema for network-hosted data.
Persistency:
   i. As described above, persistency refers to the availability or accessibility of data from a specified URL or path. The persistency can be described as a Boolean flag, where 1 indicates persistent and 0 indicates non-persistent. For example, a persistent storage is accessible from the specified URL after moving a task to a new environment during workflow execution. This can be for a scenario where a task is migrated from edge cloud to an end user device which has the media sink.
   ii. On the other hand, a non-persistent stored data needs to be retrieved and made available again for the task after moving to a new environment. This may require the MPE to replenish a local cache or a local file for making the data available to a migrated task in a transparent manner.
   iii. In case of persistent storage there may be additional information such the expected latency/delay in retrieving the data, the bandwidth for retrieval link, etc.
Consistency:
   i. Refers to the recentness of the snapshot of data available from a certain URL. In case of data that is up to date, the consistency value is 0 whereas in case of data that is not consistent consistency value will be a positive integer which is greater than 0. A positive integer value which is larger indicates data of lesser recentness. In some embodiments, the recentness can also be indicated in milliseconds. Other types may be used to show different data consistency models in the computer science, for example, weak vs strong [https://en.wikipedia.org/wiki/Consistency_model (last accessed on Oct. 4, 2021)].
Encryption:
   i. In addition to the persistency and consistency, an encryption parameter can be part of the MPE capability description. When it is provided with encryption information, for example the parameter indicates specific encryption method required, Workflow Manager shall add the support of data encryption and decryption as dynamic tasks when available by the NBMP platform. This behavior can be transparent to the tasks affected. Alternatively, the URLs for task input and output streams (media and metadata) may contain parameters as URL query parameters to indicate if the task needs to implement any decryption defined by the encryption method or is the data available to the task already decrypted. This is crucial information for the task to continue seamless execution of the task without any hindrance.

Thus, data for an MPE can be described with one or more above described parameters.

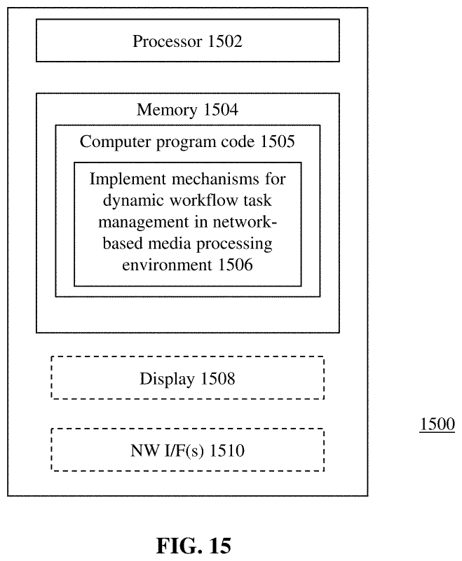

FIG. 15 is a diagram illustrating an example apparatus 1500, which may be implemented in hardware, configured to implement dynamic workflow task management in a network based media processing environment, based on the examples described herein. The apparatus 1500 comprises a processor 1502, at least one non-transitory memory 1504 including computer program code 905, wherein the at least one memory 1504 and the computer program code 1505 are configured to, with the at least one processor 1502, cause the apparatus 1500 to implement mechanisms for dynamic workflow task management in network based media processing environment 1506. The apparatus 1500 optionally includes a display 1508 that may be used to display content during rendering. The apparatus 1500 optionally includes one or more network (NW) interfaces (I/F(s)) 1510. The NW I/F(s) 1510 may be wired and/or wireless and communicate over the Internet/other network(s) via any communication technique. The NW I/F(s) 1510 may comprise one or more transmitters and one or more receivers. Some example of the apparatus 1500 include, but are not limited to, a media source, a media sink, a network based media processing source, a user equipment, a workflow manager, and a server. Some other examples, of the apparatus include, the apparatus 50 of FIG. 1 and the apparatus 400 of FIG. 4.

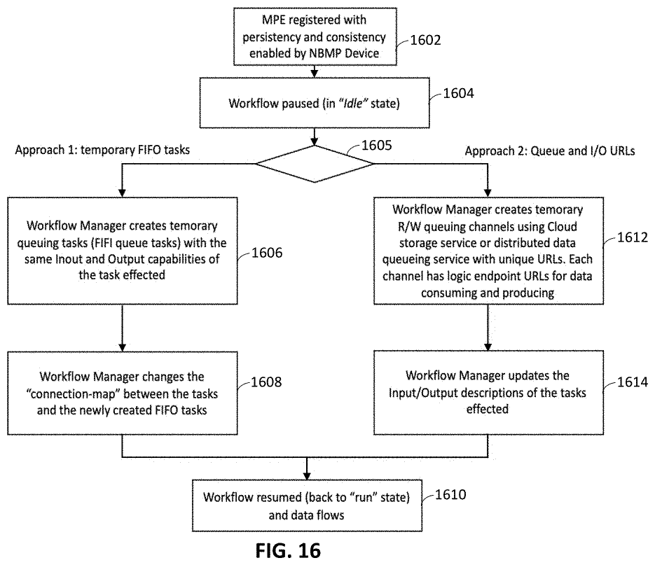

Referring now to FIG. 16, the operations performed, for respecting MPE data persistency for miming workflow and task, such as by the apparatus 1500 of FIG. 15 are depicted. As shown in block 1602, the apparatus includes means, such as the processor 1502, for enabling MPE registered with persistency, for example, by an NBMP device. As shown in block 1604, the apparatus includes means, such as the processor 1502, for pausing a workflow, for example, in an idle state. At block 1605, the workflow manager can make a decision, based on the available resources, that is, either FIFO queue functions in the Function Repository; or a system-provided queue system for structed data or a media server (e.g. RTMP server) for media data streams. Other conditions or configuration may influence the decision.

As shown in block 1608, the apparatus includes means, such as the processor 1502, for creating by a workflow manager a temporary queuing task (e.g. FIFO queues task) with same or substantially same input and output capabilities of the task effected. As shown in block 1510, the apparatus includes means, such as the processor 1502, for changing a connection-map between the tasks and the newly created FIFO tasks. Thereafter, as shown in block 1612, the apparatus includes means, such as the processor 1502, for resuming workflow (e.g. back to run state) and data flows.

In an alternate embodiment, as shown in block 1612, the apparatus includes means, such as the processor 1502, for creating by a workflow manager temporary read/write (R/W) queuing queueing channels using cloud storage service or distributed data queueing service with unique URLS. Each channel has logic endpoint URLs for data consuming and producing. As shown in block 1612, the apparatus includes means, such as the processor 1502, for updating by the workflow manager the input/output descriptions of the tasks effected. Thereafter, as shown in block 1612, the apparatus includes means, such as the processor 1502, for resuming workflow (e.g. back to run state) and data flows.

Event Driven Approach

Design: Event Notification for Processing Capability Changes on Device MPEs

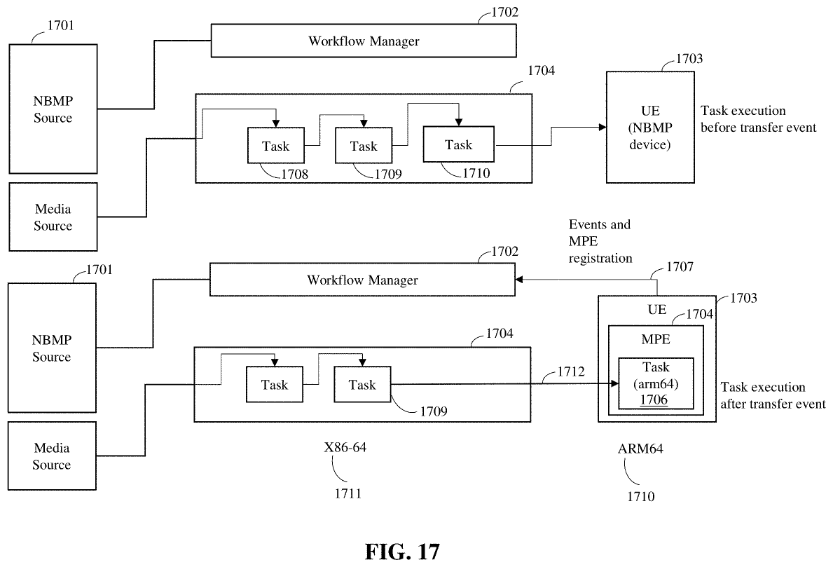

FIG. 17 depicts event notification for processing capability changes on devices 1703 in accordance with an embodiment.
Device 1703 issues events 1707 to the workflow manager 1702 report its processing capabilities including availability of certain processing functions and its implementation information
Device 1703 can register and update MPE description 1701 to the workflow manager 1702 with all information including availability of certain processing functions and is implementation information like parameters defining its run-time properties such as CPU architecture, for example, x86 vs ARM64, and the like.
Upon the requests of events and MPE registration, the workflow manager 1702 can find the task 1705 affected and re-configure the workflow running in the MPE 1704 (multiple different tasks 1705 1708 1709 can run in one MPE) to use the new task 1706 running in the new MPE 1704 in the UE 1703. For example, linking the task 1709 to the new task 1706. The media flow 1712 is redirected. The workflow manager 1702 may stop and destroy the old task 1705; or keep it in a state for future use.
The workflow manager 1702 does not move the original task 1705 to the new MPE 1704, because MPE 1704 uses different processor architecture, for example, ARM64 1710, to the MPE with different architecture 1711 (X86-64) in the cloud.

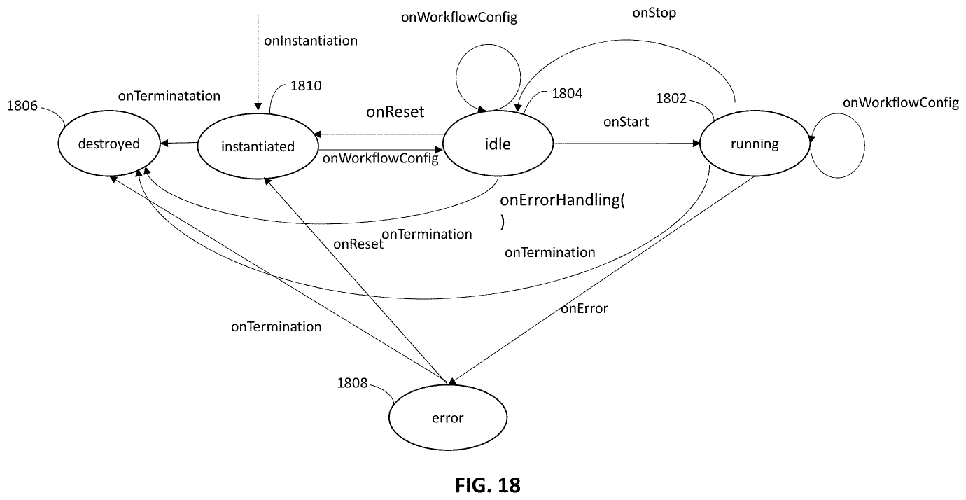

FIG. 18 describes changes in task happening during transfer of a task, in accordance with an embodiment. FIG. 18 uses the standard workflow lifecycle described in ISO/IEC 23090-8 NBMP specification to show the relevant two states: a running state 1802 and an idle state 1804. During the transfer of a task, the workflow state shall be changed from the running state 1802 to idle state 1802, if it is in the idle state 1804. Workflow re-configuration may have less or zero impact on other workflow states such as a destroyed state 1806, an error state 1808, or an instantiated state 1810. The task reconfiguration can be done either in as a soft-transfer, for example, by soft reconfiguration or a hard-transfer, for example by as a hard reconfiguration. The soft reconfiguration does not disrupt the workflow execution. For example, the Task's “connection-map” parameter (defined in the ISO/IEC 23090-8) is retained intact when a new task is being instantiated in the new location. The soft reconfiguration requires closer synchronization between the tasks and workflow manager. On the other hand, hard reconfiguration pauses the execution and restarts the execution from the new task locations. In case of hard reconfiguration, a buffer node may be needed to collect the output of previous task until the new task is fully functional.

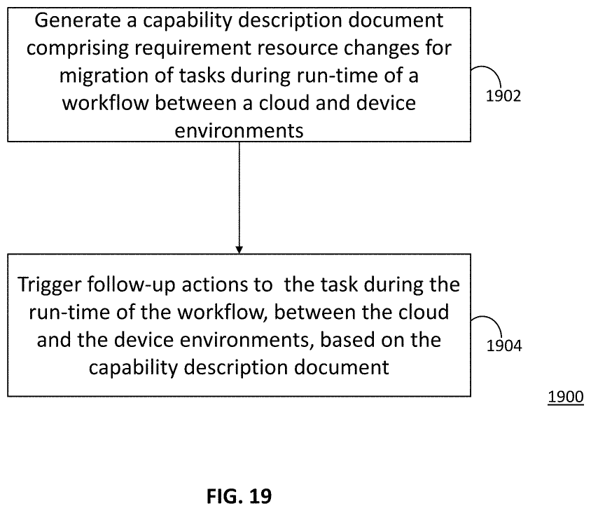

FIG. 19 is a flowchart illustrating a method 1900 for implementing dynamic workflow task management in a network based media processing environment. As shown of FIG. 15, the apparatus 1500 includes means, such as the processor 1502 or the like, to implement dynamic workflow task management in a network based media processing environment. At 1902, the method 1900 includes generating a capability description document comprising requirement changes for migration of tasks during run-time of a workflow between a cloud and device environments. The example of changes include, but are not limited to, hardware resources like memory, CPU/GPU, battery level; and available media processing functions. For example, if one function requires at least 50% of battery remaining in a device, when the battery drops below 50%, that function should stop and becomes unavailable. At 1904, the method 1900 incudes, triggering follow-up actions to the task during the run-time of the workflow, between the cloud and the device environments, based on the capability description document.

In an embodiment, the method 1900 further incorporating native functions in a processing pipeline. In another embodiment, the method 1800 includes managing lifecycle of one or more MPE and notifying the workflow manager state of each MPE of the one or more MPEs. In yet another embodiment, the method 1900 further includes managing media processing entity administration.

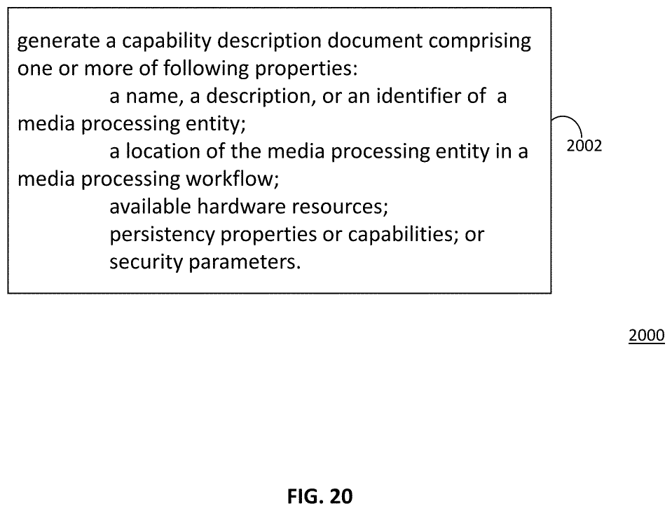

FIG. 20 is a flowchart illustrating a method 2000 for generating a capability description document, in accordance with an embodiment. FIG. 19 is a flowchart illustrating a method 1900 for implementing dynamic workflow task management in a network based media processing environment. As shown of FIG. 15, the apparatus 1500 includes means, such as the processor 1502 or the like, to implement dynamic workflow task management in a network based media processing environment. At 2002, the method 2000 includes generating a capability description document comprising one or more of following properties:
a name, a description, or an identifier of a media processing entity;
a location of the media processing entity in a media processing workflow;
available hardware resources;
persistency properties or capabilities; or
security parameters.

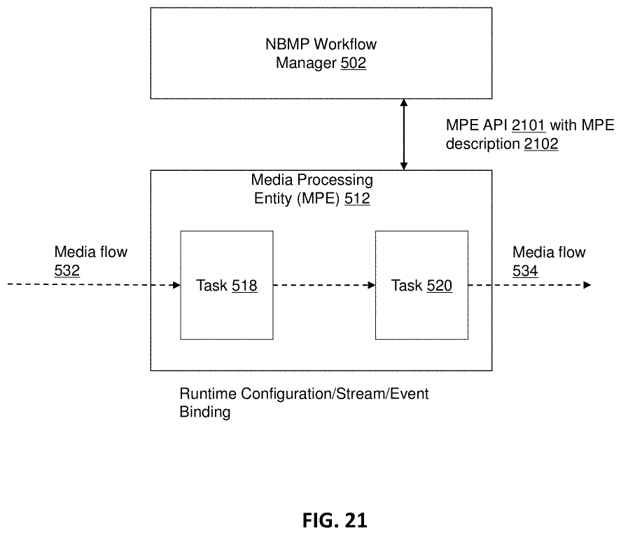

FIG. 21 is a diagram illustrating the communication between the MPE 512 and the NBMP workflow manager 502, in accordance with an embodiment. The communication is through an MPE API 2101, with MPE description 2102, from the MPE 512 to the NBMP workflow manager 502. The MPE 512 can communicate with the NBMP workflow manager 502 in one or bi-directional manners. The connection can be made shortly, or a persistent connection can be used.

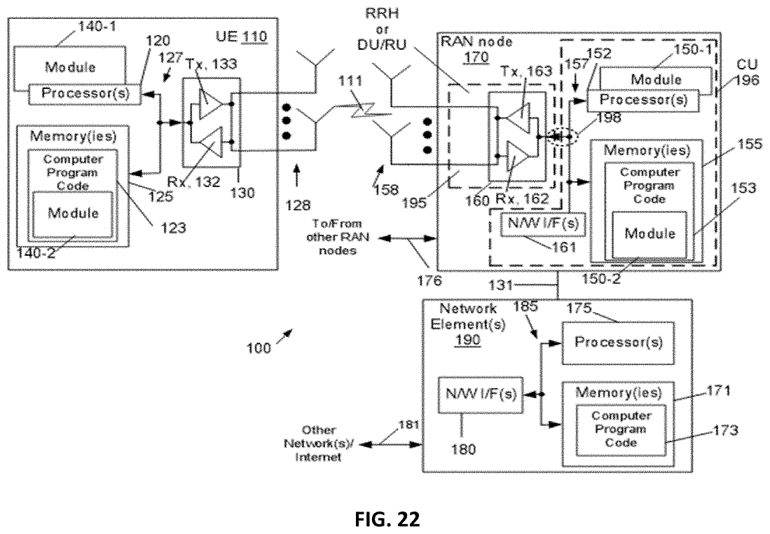

Turning to FIG. 22, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement dynamic workflow task management in a network based media processing environment based on the examples described herein. Computer program code 173 may also be configured to implement dynamic workflow task management in a network based media processing environment.

As described above, FIGS. 16, 19 and 20 include flowcharts of an apparatus (e.g. 50, 400, 1500, or 100), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 58, 404, 1504, or 125) of an apparatus employing an embodiment of the present invention and executed by processing circuitry (e.g. 56, 402, 1502, or 120) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowcharts of FIGS. 16, 19, and 20. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least one processor; and
at least one non-transitory memory including computer program code;
wherein the at least one memory and the computer program code are configured to, with the at least one processor, cause the apparatus at least to perform:
generate a capability description document comprising requirement resource changes for migration of tasks during run-time of a workflow between a cloud and device environments; and
trigger follow-up actions to migrate the tasks during the run-time of the workflow, between the cloud and the device environments, based on the capability description document.

2. The apparatus of claim 1, wherein the capability description document comprises a media processing entity (MPE) capability description document (MDD).

3. The apparatus of claim 2, wherein the apparatus comprises a plurality of media processing entities (MPE's) registered for specific processing tasks.

4. The apparatus of claim 3, wherein the media processing entities exists over multiple processing environments comprising cloud and device environments.

5. The apparatus of claim 1, wherein the capability description document comprises one or more of following capabilities:
a name, a description, and an identifier;
a repository of built in functions;
total and currently available hardware resources;
issuing events in case of reducing resource through notification, reporting, and monitoring descriptions.

6. The apparatus of claim 1, wherein to generate the capability description document the apparatus is further caused to use the network based media processing (NBMP) workflow description document, wherein the NBMP descriptors describe notification, reporting, and monitoring of the MPE.

7. The apparatus of claim 1, wherein the task comprises capability to be moved to a different MPE based on an event notification received by a workflow manager.

8. The apparatus of claim 1, wherein the apparatus comprises a plurality of media processing entities (MPEs) defined through different MPE capability descriptor document (MDD).

9. The apparatus of claim 1, wherein the apparatus is further caused to:
manage lifecycle of one or more MPE; and
notify, to the workflow manager, a state of each MPE of the one or more MPEs.

10. An apparatus comprising:
at least one processor; and
at least one non-transitory memory including computer program code;
wherein the at least one memory and the computer program code are configured to, with the at least one processor, cause the apparatus at least to perform:
generate a capability description document comprising one or more of following capabilities or properties:
a name, a description, or an identifier of a media processing entity;
a location of the media processing entity in a media processing workflow;
available hardware resources;
persistency properties or capabilities; or
security parameters.

11. The apparatus of claim 10, wherein the capability description document comprises capabilities of storage definition.

12. The apparatus of claim 10, wherein the capabilities of storage definition comprise one or more of persistency properties or consistency properties.

13. The apparatus of claim 10, wherein a media processing entity comprises priority policies regarding availability of resources.

14. A method comprising:
generating a capability description document comprising one or more of following properties:
a name, a description, or an identifier of a media processing entity;
a location of the media processing entity in a media processing workflow;
available hardware resources;
persistency properties or capabilities; or
security parameters.

15. The method of claim 14, wherein the capability description document comprises capabilities of storage definition.

16. The method of claim 15, wherein the capabilities of storage definition comprise one or more of persistency properties or consistency properties.

17. The method of claim 14, wherein a media processing entity comprises priority policies regarding availability of resources.

18. The method of claim 14 further comprising managing media processing entity administration.

19. The method of claim 18, wherein media processing entity administration comprises a dynamic media processing entity device discovery, a media processing entity subscription, and a media processing entity un-subscription.

20. The method of claim 18, wherein the media processing entity administration is managed via one or more application programming interfaces (APIs).

21. The method of claim 20, wherein the one or more application programming interfaces comprises interfaces for one or more of following operations:
a media processing entity discovery operation, wherein the media processing entity discovery operation comprises a mechanism to discover devices with media processing capabilities using the MPE capability description document (MDD);
a media processing entity subscription operation to register a device as one or more media processing entities with the capability description document;
a media processing entity authentication operation to authenticate the device as one or more media processing entities with the capability description document;
a media processing entity sign-off operation to un-subscribe the media processing entity of the device from a processing pipelines; or
a capability change operation, used by the device, to inform a workflow manager about changes in resources of the media processing entity.

22. A computer program product comprising a computer readable storage medium having program code portions stored thereon, the program code portions configured, upon execution, to:
generate a capability description document comprising one or more of following capabilities or properties:
a name, a description, or an identifier of a media processing entity;
a location of the media processing entity in a media processing workflow;
available hardware resources;
persistency properties or capabilities; or
security parameters.
